(19) United States
(12) Patent Application Publication
(10) Pub. No.: US 2006/0221955 A1
(43) Pub. Date: Oct. 5, 2006

(54) IP addressing in joined private networks

(76) Inventor: Mark Enright, Soquel, CA (US)

Correspondence Address: Norman E. Carte;MacPHERSON KWOK CHEN & HEID LLP, Suite 226, 1762 Technology Drive, San Jose, CA, 95110, US

(21) Appl. No.: 11/099,056

(22) Filed: Apr. 5, 2005

(51) Int. Cl. H04L 12/56; H04L 12/28

(52) U.S. Cl. 370/389

(57) ABSTRACT

Systems and methods are disclosed for mitigating addressing conflicts in joined networks. For example, Internet Protocol (IP) addressing conflicts in a virtual private network (VPN) can be mitigated by automatically changing an address of a gateway of one network when another network is placed in communication therewith. A destination network address translation (DNAT) filter can be used to direct packets to the new address of the gateway.

### TECHNICAL FIELD

The present invention relates generally to networking. The present invention relates more particularly to a method for preventing user confusion arising from the random provisioning of a local area network on a home gateway.

### BACKGROUND

Home and small business networks are increasing in popularity as the price of gateways, routers and access points continues to decrease and as the task of installing and using such equipment becomes easier. Such private networks provide families and small businesses with the benefits of having a local area network. For example, they can easily share files, use email, and have Internet access.

Sometimes it is desirable to join two or more such private networks together. Joining two or more private networks together defines one larger network and can make file sharing and other communications between the participating computers easier. Such joining may be accomplished, for example, via the use of a Virtual Private Network (VPN). VPNs use a wide area network, such as the Internet, to provide logical connection between private networks.

For example, a home network can be joined to a small business network. Using a VPN, an employee can easily access work files from home and visa-versa. Thus, there are substantial advantages to implementing VPNs.

Generally, such VPNs provide intercommunication between private networks without problems. The existence of private address space is discussed in RFC-1918. This document describes a common technique used by home gateways, access points, and routers known as Network Address Translation (NAT). The use of NAT allows gateways, access points, and routers to assign private or local Internet Protocol (IP) addresses to devices of the private network. That is, the gateway, access point, or router considers the computers of the private network to be within its administrative domain and assigns them local IP addresses according to RFC-1918.

By default, the local IP addresses that are assigned to the computers of the private network by the gateway, access point, or router are those that are provisioned for use by the manufacturer of the gateway, access point, or router. That is, these are the local IP addresses that are stored in the gateway, access point, or router, so that they can be assigned as needed.

Thus, the private IP addresses assignable by particular model of gateway, access point, or router to other devices tend to be identical. Sometimes, this is even true for different models or types for products for a given manufacturer. Both the gateways and routers of a given manufacture may assign the same default local addresses, for example. This results in private networks having computers with the same local network addresses as those of the computers in other private networks.

Further, the default local IP addresses of the gateways, access points, and routers themselves tend to be standardized. Such standardization more readily facilitates device configuration and support. The documentation for a particular model of gateway, access point, or router generally refers to a default local IP address for that device. If a user is requesting telephone support regarding the installation or operation of a gateway, access point, or router, then support personal can take advantage of such common default local IP addresses when instructing the user or remotely configuring or testing the device.

As a consequence of such of gateways, access points, and routers having common default addresses for use in provisioning and of the gateways, access points, and router themselves having the same local IP addresses, there can be private networks that have identical internal addressing. Indeed, since the RFC-1918 private networks tend to have identical addressing schemes for a particular model of gateway, access point, or router, the likelihood of two private networks having computers with the same local IP address is actually quite large.

This is not necessarily a problem. As long as the gateway is using network address translation (NAT) to lend use of its global IP address to computers on its private network, the external IP addressing provided through the network's Internet Service Provider will give the network, and consequently the computers within the network, unique global IP addresses. However, when two private networks are joined via a VPN, they effectively become one larger network. In this instance, unique addresses for all of the computers of the joined network are necessary to avoid addressing conflicts that will prevent proper network operation. Unfortunately, RFC-1918 does not provide a solution to this problem and it is sometimes not feasible to coordinate RFC-1918 local addressing space among private networks.

Thus, in some instances reconfiguration of a gateway, access point, or router is necessary to avoid address conflicts between computers on networks that are joined via a VPN. This reconfiguration can be accomplished by manually changing the default IP address of the gateway (this is the default LAN IP address or private network address, and is not the global IP address), access point, or router of one of the private networks, as well as by changing the local addresses of the computers on the private network. Thus, the local IP addresses of the private networks will be different. In this manner, addressing conflicts will be avoided.

Although changing the default IP address of one of the private networks is not difficult, it is inconvenient. Further, it necessitates that maintenance and support personnel be aware of the change. Indeed, there is generally an expectation on the part of network administrators and support personnel that provisioning and control data packages for gateways, routers, and access points can be sent to the manufacturer's default RFC-1918 local IP address. Changing the local IP address of the device means that the consumer may have trouble accessing the device in order to provision it. Any addressing of the gateway, access point, or router, such as for configuration, must subsequently be performed using the new IP address. Therefore, changing the private IP address of the gateway, access point, or router is not always desirable.

In view of the foregoing, it is desirable to provide a way to join two private networks, such as via a VPN, that does not require that a person change the IP address of a gateway, access point, router, or the like in order to prevent addressing conflicts.

### BRIEF DESCRIPTION OF THE DRAWINGS

FIG. 1 is a block diagram showing two private networks joined together, such as via a VPN using the Internet, according to an exemplary embodiment of the present invention; and

FIG. 2 is a flow chart showing an exemplary embodiment of the method for mitigating addressing conflicts in joined private networks, according to one embodiment of the present invention.

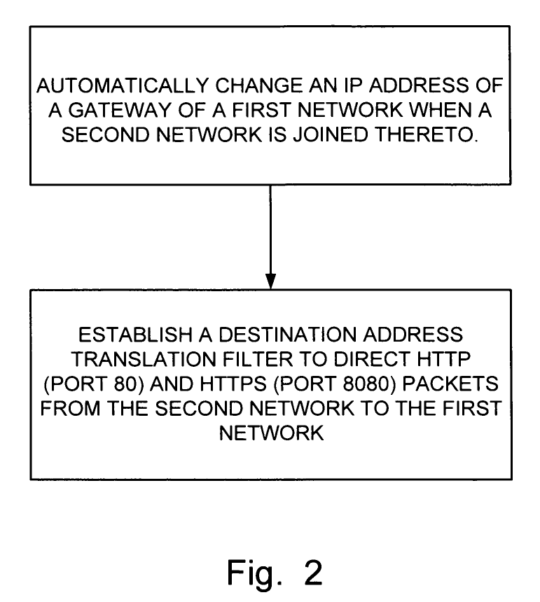

Embodiments of the present invention and their advantages are best understood by referring to the detailed description that follows. It should be appreciated that like reference numerals are used to identify like elements illustrated in one or more of the figures.

### DETAILED DESCRIPTION OF THE PREFERRED EMBODIMENTS

Systems and methods are disclosed for mitigating addressing conflicts in joined private networks. For example, Internet Protocol (IP) addressing conflicts in a virtual private network (VPN) can be mitigated by automatically changing an address of a gateway, access point, router or other device of one network when another network is placed in communication therewith. A network address range can also be changed from the default RFC-1918 address space to a different RFC-1918 address space. A destination network address translation filter (DNAT) can then be used to direct packets originating in the private network, such as http and https packets, to the new address of the gateway. In this manner, ambiguous addressing is prevented among the joined networks.

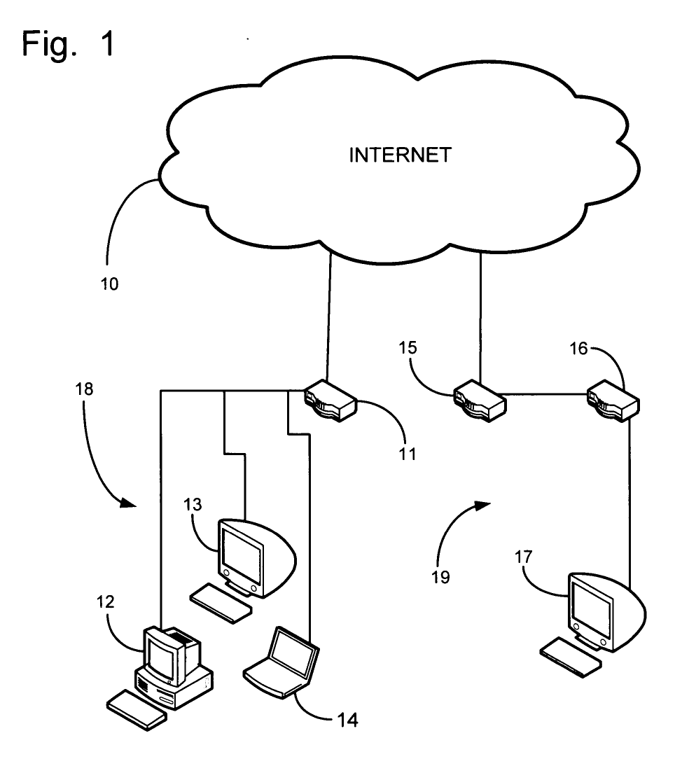

FIG. 1 shows a first private network 18 and a second private network 19, which can be joined so as to define a larger single network. The first private network 18 can, for example, comprise a security gateway 11 and a plurality of computers 12-14. The second private network 19 can, for example, comprise a network address translation (NAT) router 15, another router 16, and at least one computer 17. The first private network 18 and/or the second private network 19 can comprise a variety of additional items, such as servers, client computers, switches, routers, access points, gateways, hubs, bridges, printers, scanners, and stand alone memory devices.

The first private network 18 can be joined to the second private network 19 via a VPN defined using a wide area network (WAN), such as the Internet 10. However, as mentioned above, such interconnection of two private networks provides the potential for IP addressing conflicts. IP addressing conflicts can occur, for example, when two gateways, access points, routers, or the like, typically made by the same manufacturer, facilitate interconnection to their respective private networks.

The conflict that is most likely conflict to occur is when a computer (RoadWarrior) on one private network attempts to set up a VPN to another private network. In this case, conflict is likely to occur when both NAT routers are made by the same company and one of the routers is acting as Security Gateway facilitating the VPN interconnection.

As those skilled in the art will appreciate, private networks can be connected to wide area networks (WLANs) via a variety of devices, such as gateways, access points, and routers. The term gateway, as used herein, can include all such devices. Thus, use of the term gateway is by way of example only, and not by way of limitation.

The gateways of such private networks can have identical local IP addresses, since the IP addresses are typically the default addresses assigned by the manufacturer. Further, the gateways can assign the same local IP addresses to the computers on their respective private networks.

Security gateway 11 of the first private network 18 has a global IP address by which it can be accessed via the Internet 10. It can also have a local IP address of 192.168.1.1 and its associated private network, comprised of computers 12-14 can have local IP addresses between 192.168.1.0 and 192.168.1.24, for example.

Similarly, NAT router 15 of the second private network 19 has a global IP address. It can also have a local address between 192.168.1.0 and 192.168.1.24 and can assign the remaining addresses within this range to other devices on the second private network 19 (such as to router 16).

Addressing conflicts can occur when the first private network 18 and the second private network 19 are joined by a VPN. In this instances, the range of addresses of 192,168.1.0 to 192.168.1.24 are available on both the first private network 18 and the second private network 19. Thus, it is likely that there will be at least some overlap in addressing on the VPN.

This problem of such conflicting RFC-1918 address space typically occurs when an attempt is made to join two or more private networks that utilize gateways or routers that have the same default local IP address or range of assignable addresses. In the example above, this happened when a host within one RFC-1918 address space was joined in a VPN to another host within a similar RFC-1918 address space through security gateway 11. In this instance, NAT router 15 and/or router 16 have conflicting address spaces with respect to security gateway 11 and/or computer 12-14.

One or more aspects of the present invention provide a two part solution to this problem. First, the opportunities for such conflicts are mitigated. Second, user confusion resulting from the implementation of the first part of the solution is mitigated.

According to one embodiment of the present invention, an address of first network 18 is automatically changed when second network 19 is placed in communication therewith. Random RFC-1918 addresses can be assigned before VPN setup. This can occur either during an initial installation of the gateway into the network, i.e., when the gateway is first purchased and brought into the home, or when the first provisioning of a VPN is performed. There is no need to change the private address space for subsequent VPN provisioning because the random choice of RFC-1918 addresses the first time generally eliminated conflicts well enough for all other private VPNs that may be used from then on. Once the RFC-1918 network has been changed and all of the hosts in that private network have been reassigned an IP address in the new RFC-1918 address space, then there is less likelihood of private IP address collision. Communications to the devices whose addresses were changed are re-directed to the new addresses, when such communications are addressed to the old addresses of the devices.

For example, the administrator of security gateway 11 can provision security gateway 11 to enable router 16 to join to first network 18, such as via the formation of a VPN between first network 18 and second network 19. In order to avoid IP addressing conflicts, the LAN address space of first network 18 can be changed, such as to 10.x.x.x/8. That is, the IP address of computers 12-14 and/or of security gateway 11 of first network 18 are changed so that they do not conflict with the addresses of any of the devices of second network 19. These address changes can be performed automatically.

It should be noted that address space 10.x.x.x/8 is mentioned above because it is the largest private address space. However, the use of 10.x.x.x/8 is by way of example only, and not by way of limitation. Those skilled in the art will appreciate that various other private address spaces can similarly be used. Indeed, any random RFC-1918 private address space will generally work.

According to one aspect of the present invention, the address changes are detected and a destination NAT (DNAT) filter is implemented so as to redirect http (port 80 or 8080) and https (port 443) packets for the original IP addresses to the new IP addresses. Redirected packets have the destination port 80 or 443. The source IP address is from a host in the private network and the destination IP address is the default IP Address of the Gateway

Destination NAT filtering is implemented as part of the operating system, or as an add-on to the operating system. It is generally implemented using packet filters which inspect incoming/outgoing data packets. When finding packets are found that meet some criteria (in this case the destination address is to the default IP address or the corresponding return packet), then the packet filter code will perform destination NAT filtering. This is a widely available function.

If the address of security gateway 11 is changed, then communications with the graphical user interface (GUI) of security gateway 11 are similarly re-directed, so that communication with the GUI can be performed using the default local IP address. Thus, control layer data that is destined for the manufacturer's default RFC-1918 address of security gateway 11 is redirected to the new address of security gateway 11. In this manner, users do not have to be aware of the address change and user confusion is avoided. That is, a user such as a network administrator can continue to communicate with the GUI of security gateway 11 using the same address that they are accustomed to using, even thought the local IP address of security gateway 11 has been changed. Thus, a user is not required to remember a new, generally random, local IP address in order to access security gateway 11 for routine tasks, such as configuration.

Thus, one or more aspects of the present invention mitigate the likelihood of IP addressing conflicts occurring, while at the same time allow users to communicate with a gateway in the same manner, i.e., using the same local IP address, as described in the manufacturer's documentation for the device.

There is generally no significance as to which private network is referred to as the first private network and which private network is referred to as the second private network. Thus, for example, it can similarly be the address of the second network that can be changed to mitigate conflicts. Further, practice of the present invention is not limited to the joining of two private networks to form a larger network. Rather, any desired number of private networks may be so joined and the addresses of any necessary number of such private networks can be changed according to one or more aspect of the present invention.

The use of a VPN to join private networks is by way of example only, and not by way of limitation. Thus, private networks may be joined by any desired method according to the present invention.

Thus, one or more aspects of the present invention provide a way to join random networks, including two or more identically addressed private networks, such as via a VPN, in a manner that does not require that a person change the IP address of a gateway, access point, router, or the like. The consumer can still connect to the device using the default IP address assigned by the manufacturer for provisioning.

It is important to understand when the network IP address is changed. Typically the gateway will act as the DHCP server for the private network, and it will assign IP addresses from the private address space that the manufacture uses by default. That means that once each computer on the network has acquired an IP address, it will continue to use it as long as its lease on the address lasts (typically 1 day or more). Since the present invention attempts to eliminate conflict of address space, the actual change of private network space must occur before communication with the VPN starts, so that as each host renews its DHCP provisioned IP address it will receive a new one in the new address space. This procedure can be performed at first boot when the new gateway is brought home and first started. However, such network space reassignment can alternatively occur when the first VPN is provisioned. Alternatively, this procedure can be performed when a conflict is detected or when communication first starts. However, this may require protocols or procedures to reprovision the private IP address space on all hosts that are part of the private network.

Embodiments described above illustrate, but do not limit, the invention. It should also be understood that numerous modifications and variations are possible in accordance with the principles of the present invention. Accordingly, the scope of the invention is defined only by the following claims.

1. A method for mitigating conflicts in a network, the method comprising automatically changing an address of a first network when a second network is placed in communication therewith.

2. The method as recited in claim 1, wherein changing an address of a first network comprises changing private address space at first boot of a gateway.

3. The method as recited in claim 1, wherein changing an address of a first network comprises changing private address space when first provisioning a VPN.

4. The method as recited in claim 1, further comprising redirecting communications with a device whose address was changed such that communications addressed to the device's old address are directed to the device's new address.

5. The method as recited in claim 1, further comprising:
detecting a change of an Internet Protocol address of the first network; and
establishing a destination network address translation filter to redirect http and https packets to a new address.

6. The method as recited in claim 1, wherein changing an address of the first network comprises changing an address of a security gateway thereof.

7. The method as recited in claim 1, wherein the second network is placed in communication with the first network via the use of a virtual private network.

8. The method as recited in claim 1, wherein the address of the first network is changed to a random address within the address space of 10.x.x.x/8.

9. The method as recited in claim 1, further comprising:
detecting the change of the address of the first network; and
establishing a destination network address translation filter to redirect communications to a new address.

10. The method as recited in claim 1, wherein a user can communicate with a gateway of the first network using an unchanged address thereof.

11. The method as recited in claim 1, wherein control layer data that is destined for a manufacturer's default address is redirected to a current address of a gateway, access point, or router.

12. A network device comprising:
at least one port for facilitating communication with a network; and
circuitry configured to be in communication with a first network and to mitigate conflicts by automatically changing an address thereof when a second network is placed in communication therewith.

13. The network device as recited in claim 12, wherein changing an address of a first network comprises changing private address space at first boot of a gateway.

14. The network device as recited in claim 12, wherein changing an address of a first network comprises changing private address space when first provisioning a VPN.

15. The network device as recited in claim 12, wherein the circuitry is further configured to redirect communications with a device whose address was changed such that communications addressed to the device's old address are directed to the device's new address.

16. The network device as recited in claim 12, wherein the circuitry is further configured to:
detect a change of an Internet Protocol address of the first network; and
establish a destination network address translation filter to redirect http and https packets to a new address.

17. The network device as recited in claim 12, wherein changing an address of the first network comprises changing an address of a security gateway thereof.

18. The network device as recited in claim 12, wherein the second network is placed in communication with the first network via the use of a virtual private network.

19. The network device as recited in claim 12, wherein the address of the first network is changed to a random address within the address space of 10.x.x.x/8.

20. The network device as recited in claim 12, wherein the circuitry is further configured to:
detect the change of the address of the first network; and
establish a destination network address translation filter to redirect communications to a new address.

21. The network device as recited in claim 12, wherein a user can communicate with a gateway of the first network using an unchanged address thereof.

22. The network device as recited in claim 12, wherein the circuitry is configured such that control layer data that is destined for a manufacturer's default address is redirected to a current address of a gateway, access point, or router.

23. A network device comprising:
means for communicating with a network; and
means for mitigating conflicts by automatically changing an address of the network when a second network is placed in communication with the network.
